(19) United States
(12) Patent Application Publication
(10) Pub. No.: US 2018/0190114 A1
(43) Pub. Date: Jul. 5, 2018

(54) TRAFFIC DIVERSION SIGNALLING SYSTEM AND METHOD

(71) Applicant: Yogesh Agarwal, Gurgaon (IN)

(72) Inventor: Yogesh Agarwal, Gurgaon (IN)

(21) Appl. No.: 15/693,536

(22) PCT Filed: Jan. 14, 2016
(86) PCT No.: PCT/IB2016/050155

§ 371 Date: Sep. 1, 2017

(30) Foreign Application Priority Data
Mar. 3, 2015 (IN) 603/DEL/2015

(51) Int. Cl. G08G 1/082; G08G 1/083

(52) U.S. Cl. CPC G08G 1/082; G08G 1/083

(57) ABSTRACT

The present invention provides a traffic diversion system at a traffic intersection which comprises a traffic signal arrangement including a straight-through signal, a stop signal, a ‘C’ signal or an inverse ‘C’ signal. The traffic diversion system at a traffic intersection further provides a provision for two opposite lanes to open at a time and direct right turn is prohibited. According to an embodiment, the vehicle which intends to take right turn will be first required to take a left turn and then a ‘U’ turn upon the ‘C’ signal indicator. The ‘C’ signal indicator will be introduced along with the other traffic signals so that a vehicle takes the ‘C’ turn only when the ‘C’ signals indicator is ‘green’.

### FIELD OF THE INVENTION

The present invention generally relates to a system and method for traffic diversion at a traffic intersection and more specifically to a traffic diversion signalling system to enable traffic to flow more easily and efficiently and thus reducing the waiting time at signal crossings.

### BACKGROUND OF THE INVENTION

Traffic congestion on road networks is nothing but slower speeds, increased trip time and increased queuing of the vehicles. When the number of vehicles exceeds the capacity of the road, traffic congestion occurs. In the metropolitan cities across the world traffic congestion is a major problem. Traffic congestion is caused when the demand exceeds the available road capacity. There are various reasons which lead to traffic congestion such as failure of signals, poor law enforcement and bad traffic management. One of the major problems with the present traffic system and management across the world is that the existing traffic system cannot be expanded any more. Traffic congestion for any country may lead to negative impact on economy, environment and overall quality of life and developments of the people. The only possible practical option available is to try and implement better management with the existing traffic systems and methods.

There are various conventional systems and methods available for traffic management such as traffic signals are located on roadways to control the flow of traffic through intersections and other areas. A typical traffic signal includes three phases—a red phase, a green phase, and a yellow phase. With the sustained and rapid economic development across the world, the number of vehicles on roads are increasing dramatically, growing urban road congestion, and thereby traffic congestion has become an international issue. A typical driver spends significant time idling in traffic congestion. Air pollution and energy consumption may be significantly serious due to exhaust gases emitted during the idling of vehicles waiting for traffic signals to change. Furthermore, a lot of this time is spent idling behind traffic signals.

To cope with the traffic congestion problems, multi-level crossings including overpasses and underpasses have been conventionally constructed. However, construction of such alternative crossing structures suffers from various disadvantages such as enormous construction costs, significant maintenance and management expenses, and detrimental effects on the beauty of cities.

According to the traditional four way traffic signal design, a vehicle in any particular lane has to wait for the other three lanes to turn off in order to pass the crossing. If each signal possesses a waiting time of 1 minute, the total waiting time duration sums up to 3 minutes.

Therefore, there exists a need to improve the traffic signalling system and method which can be implemented to improve the flow of traffic smoothly with minimum waiting time for a vehicle at any traffic signal.

Therefore, the present invention has been conceived in view of overcoming the drawbacks discussed above, and it is an object of the present invention to provide an intersection system which is capable of achieving smooth vehicular traffic flow at intersections by simplification of a traffic signal system into a two-phase signal scheme and is also capable of significantly increasing traffic capacity of intersections by reduction of a traffic signal waiting time.

### SUMMARY OF THE INVENTION

The present invention provides a traffic diversion system at a traffic intersection which comprises a traffic signal arrangement including a straight-through signal, a stop signal, a ‘C’ signal or an inverse ‘C signal. The traffic diversion system at a traffic intersection provides provision for two straight-through signals to open at a time and direct right turn is prohibited.

According to an exemplary embodiment of the present invention, the traffic signal arrangement provides a provision for diverging vehicles which intends to turn right in a left-hand traffic system, by directing the vehicles to first take a left turn and then a ‘U’ turn upon the ‘C’ signal indicator being enabled and to orient themselves in a waiting/moving position for the straight-through signal to be enabled.

According to an exemplary embodiment of the present invention, the traffic signal arrangement provides a provision for diverging vehicles which intends to turn left in a right-hand traffic system, by directing the vehicles to first take a right turn and then a ‘U’ turn upon the inverse ‘C’ signal indicator being enabled and to orient themselves in a waiting/moving position for the straight-through signal to be enabled.

### BRIEF DESCRIPTION OF THE DRAWINGS

The advantages and features of the present invention will be better understood with reference to the following detailed description and claims taken in conjunction with the accompanying drawing, in which:

FIGS. 1, 2 and 3 illustrates a traditional four way traffic signal design.

FIG. 4 illustrates a traffic signalling design in which two opposite straight-through signals being open at a time.

FIG. 5 illustrates a traffic signalling design in which two opposite straight-through signals being open at a time and direct right turn is prohibited.

FIG. 6 illustrates a traffic signalling design with multiple ‘C’ turn cuts along the bidirectional divider 601 for dividing the traffic moving in opposite directions.

FIG. 7 illustrates a traffic signalling design with a provision of a separate lane for the vehicles taking C turn and entering into a separate lane through ‘C’ turn cuts.

FIG. 8 illustrates a traffic signalling design with a ‘U’ turn indicator at the ‘C’ turn cuts along the bidirectional divider.

FIG. 9 illustrates a traffic signalling design with multiple ‘U’ turn's indicator at the ‘C’ turn cuts along the bidirectional divider.

### DETAILED DESCRIPTION OF THE INVENTION

The exemplary embodiments described herein detail for illustrative purposes are subject to many variations in structure, design and layout. It should be emphasized, however, that the present invention is not limited to a particular structure, design and layout as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The exemplary mode for carrying out the invention is presented in terms of its exemplary embodiments. However, the exemplary embodiments described herein detail for illustrative purposes and are subject to many variations. It is understood that various omissions and substitutions of equivalents are contemplated as circumstances may suggest or render expedient, but are intended to cover the application or implementation without departing from the spirit or scope of the present invention.

The terms “a” and “an” herein do not denote a limitation of quantity, but rather denote the presence of at least one of the referenced item.

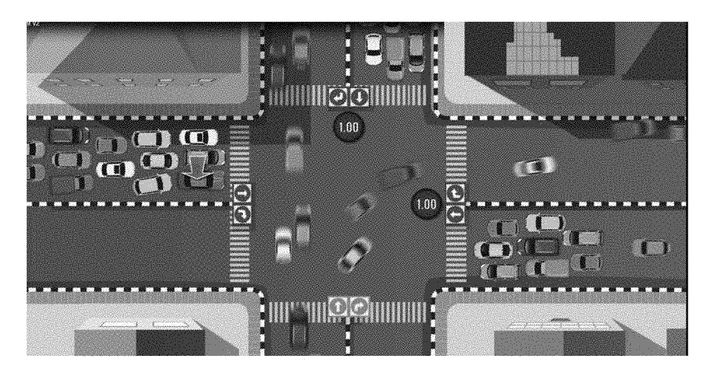

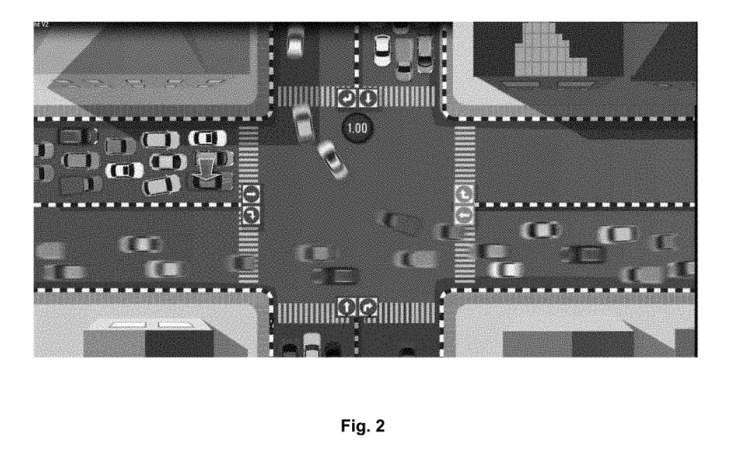

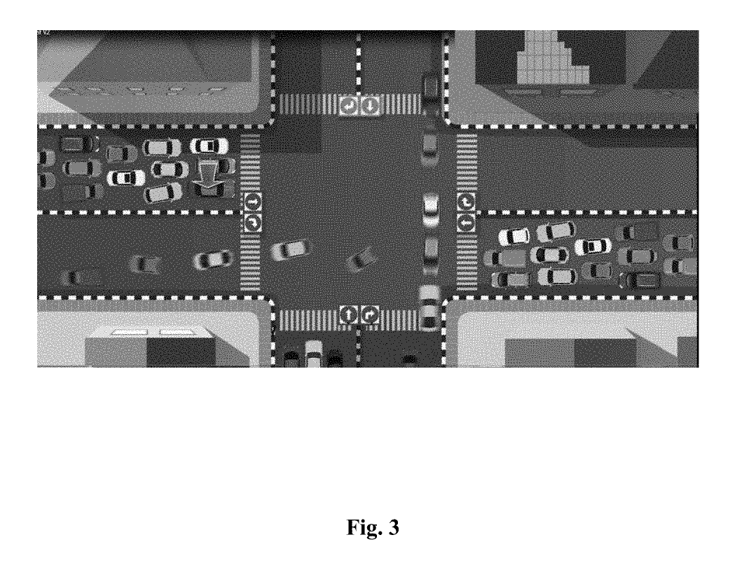

FIGS. 1, 2, & 3 illustrates a traditional four way traffic signal design in which a vehicle in any particular lane has to wait for the signals of the other three lanes to turn off in order to pass the crossing. If each signal possesses a waiting time of 1 minute, than the total waiting time duration sums up to 3 minutes.

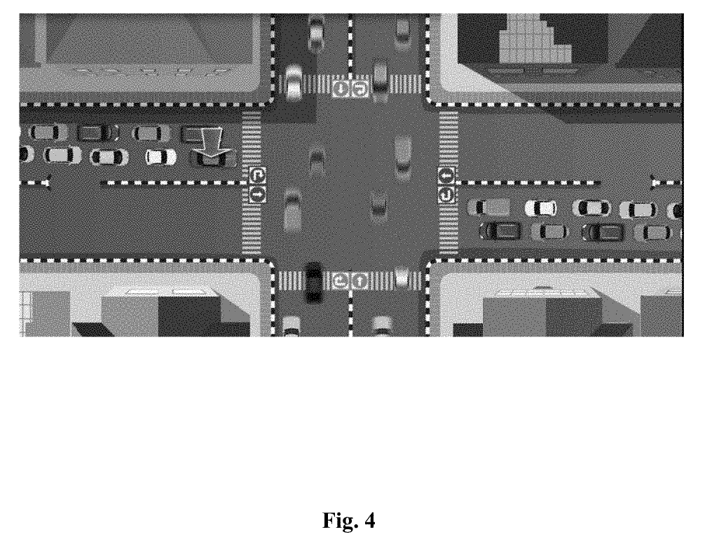

FIG. 4 illustrates one of the aspects of the traffic signalling design in which two opposite straight-through signals being open at a time and a vehicle has to wait for just 1 lane to pass for its turn which reduces the waiting time to 1 minute from 3 minutes. Furthermore, there would be no right turns in a left-hand traffic system and no left turn in a right-hand traffic system on the crossings so that two opposite straight-through signals being allowed to pass at the same time.

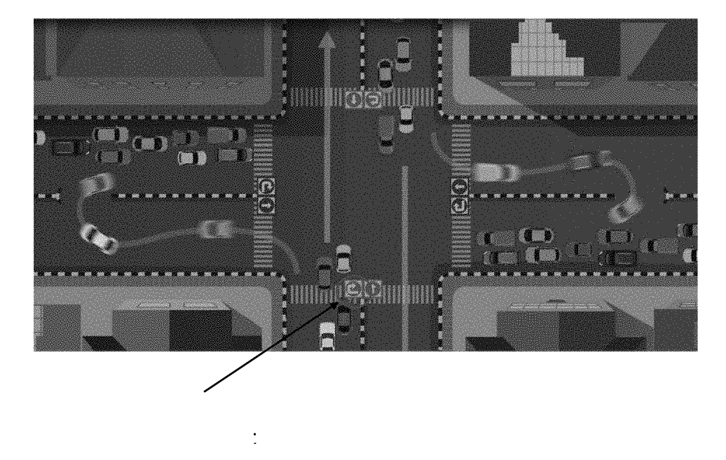

FIG. 5 illustrates the proposed traffic signalling design at a traffic intersection comprising a traffic signalling arrangement including a straight-through signal, a stop signal, a ‘C’ signal or an inverse ‘C’ signal which provides a provision for two opposite straight-through signals being allowed to pass at the same time. Further, the traffic diversion system according to an embodiment provides a provision for diverging the route for the vehicles intended to turn right when the ‘C’ signal indicator 501 is enabled in a left-hand traffic system and diverging the route for vehicles intended to turn left in a right-hand traffic system.

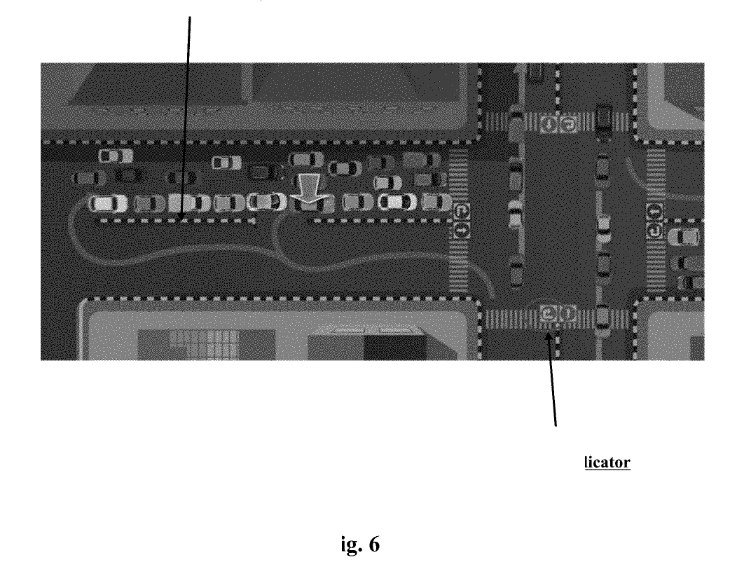

FIG. 6 illustrates another aspect of the proposed traffic signalling design as illustrated in FIG. 5 in which multiple ‘U’ turn cuts is provided along the bidirectional divider 601 so that any vehicles intended to take ‘C’ turn can easily cross through any of the ‘U’ turn cuts along bidirectional divider 601. For example, when the ‘C’ signal indicator 501 shows green light, any vehicle intended to turn right can first make a left turn and thereupon can pass through any of the multiple ‘U’ turn cuts provided along the bidirectional divider 601 and finally can drive through upon the enablement of the straight through signal at the traffic intersection.

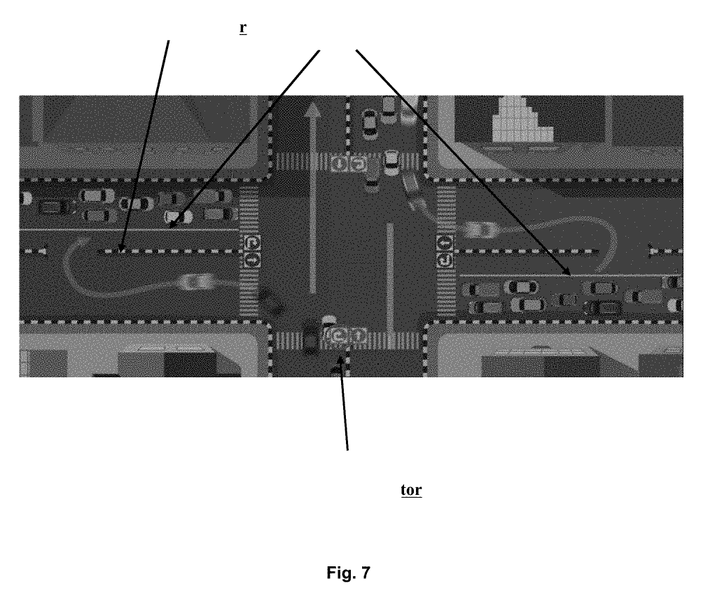

FIG. 7 illustrates another aspect of the proposed traffic signalling design at a traffic intersection in which an optional separate lane 701 is provided for the vehicles which takes ‘C’ turns upon the enablement of the ‘C’ signal indicator 501 and enters into the separate lane 701 through the ‘U’ turn cuts to avoid conflicting traffic from behind. Further, the separate lane 701 can be formed by road markings or the separate lane 701 can be formed using the road barrier. Furthermore, the separate lane 701 is an optional element and may only be implemented depending upon the width of the road.

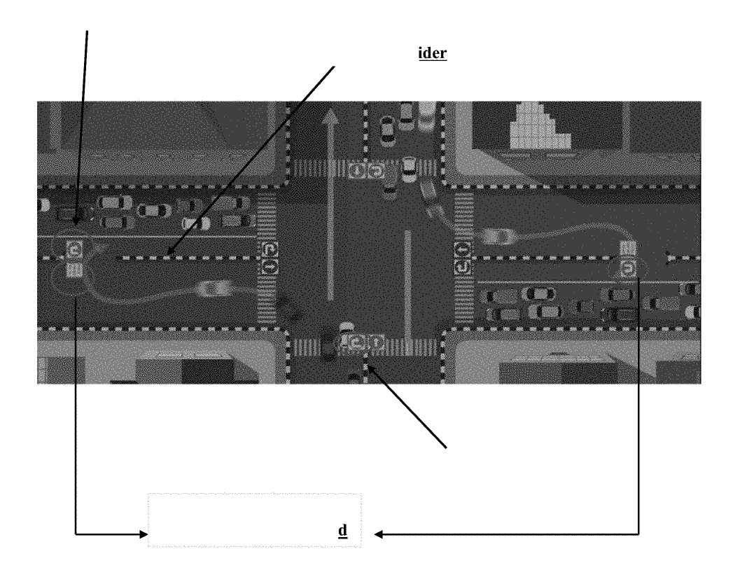

FIG. 8 illustrates another aspect of the proposed traffic signalling design in which a ‘U’ turn indicator 802 is provided at the ‘C’ turn cuts along the bidirectional divider 601. The ‘U’ turn indicator 802 indicates the availability based on the traffic congestion for the vehicles to enter into the ‘C’ turn cuts upon taking the left turn upon ‘C’ signal indicator shows green signal. Further, the U turn indicator 802 has the provision to display the position of next subsequent ‘U’ turn ahead. For example, if a vehicle which intended to turn right, first take left turn upon enablement (green signal) of the ‘C’ signal indicator 501 and thereby tries to enter into the first ‘C’ turn cut. To avoid traffic congestion on a single ‘U’ turn, The ‘U’ turn indicator 802 may also provide with the display which shows the availability of subsequent ‘U’ turn ahead such as “U turn 100 meters ahead 801”.

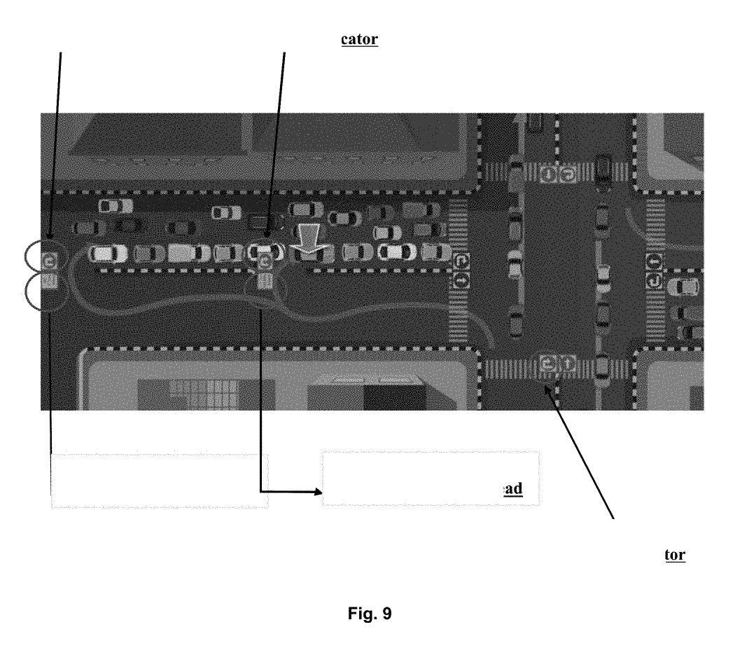

FIG. 9 illustrates yet another aspect of the proposed signalling design which may have multiple ‘U’ turns signal indicators (802 & 902) at the ‘C’ turn cuts along the bidirectional divider 601. Further, first ‘U’ turn indicator 802 may display as “U turn 100 meters ahead 801”. Subsequent ‘U’ turn indicator 902 may display as “No U turn ahead 901”. In FIG. 9, only two U turn indicators (802 & 902) are shown. However, the present invention is not limited to only two ‘U’ turn indicators and there may be multiple ‘U’ turn indicators at the ‘C’ turn cuts along the bidirectional divider 601.

The present invention increases the probability of finding green lights on the traffic signals. According to traditional design, a light would turn green 15 times in one hour (assuming a waiting time of 3 minutes). However, according to the present invention, a signal would turn green 30 times in one hour, thus increasing the frequency of green signals and reducing traffic congestions

The foregoing descriptions of exemplary embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the present invention.

I claim:

1. A traffic diversion system at a traffic intersection, comprising:
a traffic signal arrangement including a straight-through signal, a stop signal, and a ‘C’ signal or an inverse ‘C’ signal;
wherein the traffic signal arrangement provides provision for two opposite straight-through signals being open at a time,
wherein the traffic signal arrangement provides provision for diverging vehicles intended to turn right in a left-hand traffic system, by directing vehicles to take a left turn and a ‘U’ turn upon the ‘C’ signal indicator being enabled and to orient themselves in a waiting/moving position for the straight-through signal to be enabled, and
wherein the traffic signal arrangement provides provision for diverging vehicles intended to turn left in a right-hand traffic system, by directing vehicles to take a right turn and a ‘U’ turn upon the inverse ‘C’ signal indicator being enabled and to orient themselves in a waiting/moving position for the straight-through signal to be enabled.

2. The traffic diversion system as claimed in claim 1, further comprising
at least a passage through a ‘U’ turn cut along a bidirectional divider enabling the vehicles to enter into the passage after taking the left turn upon enablement of the ‘C’ signal indicator in a left-hand traffic system.
at least a passage through a ‘U’ turn cut along a bidirectional divider enabling the vehicles to enter into the passage after taking the right turn upon enablement of the inverse ‘C’ signal indicator in a right-hand traffic system.

3. The traffic diversion system as claimed in claim 2, further comprising at least one ‘U’ turn indicator at the ‘U’ turn cut along the bidirectional divider which indicates the availability of next “U” turn to avoid traffic congestion.

4. The traffic diversion system as claimed in claim 1, further comprising a separate lane for the vehicles intended to follow ‘C’ turn indicator or an inverse ‘C’ signal.
